(19) United States
(12) Patent Application Publication
(10) Pub. No.: US 2012/0029117 A1
(43) Pub. Date: Feb. 2, 2012

(54) ADHESIVE FILM FOR SEMICONDUCTOR ASSEMBLY

(75) Inventors: Han Nim CHOI, Uiwang-si (KR); Ki Tae Song, Uiwang-si (KR); Chi Seok Hwang, Uiwang-si (KR); Hea Kyung Kim, Uiwang-si (KR); Chang Beom Chung, Uiwang-si (KR)

(73) Assignee: CHEIL INDUSTRIES, INC., Gumi-si (KR)

(21) Appl. No.: 13/267,225

(22) Filed: Oct. 6, 2011

Related U.S. Application Data
(62) Division of application No. 12/292,874, filed on Nov. 28, 2008.

(30) Foreign Application Priority Data
Nov. 28, 2007 (KR) 10-2007-0122101

(51) Int. Cl. C09J 163/02; C09J 133/14; C09J 161/10

(52) U.S. Cl. 523/434

(57) ABSTRACT

An adhesive film composition includes a polymer binder; a curable resin; and about 40 to about 60 wt. % of solvent, wherein the solvent is a binary solvent consisting essentially of at least a first solvent with a boiling point of about 40° C. to about 100° C. and at least a second solvent with a boiling point of about 140° C. to about 200° C.

### CROSS REFERENCE TO RELATED APPLICATION

This is a divisional application based on pending application Ser. No. 12/292,874, filed Nov. 28, 2008, the entire contents of which is hereby incorporated by reference.

### BACKGROUND OF THE INVENTION

1. Field of the Invention

Embodiments relate to an adhesive composition for die bonding in semiconductor assembly, an adhesive film including the same, a dicing die-bonding film including the same, a device package including the same, and associated methods.

2. Description of the Related Art

Among conventional adhesive compositions for adhesive films having high reliability used in semiconductor assembly, an Ag paste has been mostly used to bond at least two semiconductor devices, or a semiconductor device with a supporting element. The Ag paste has some disadvantages including, for example, abnormal conditions in wire bonding caused by protrusion or inclination of a semiconductor device, foaming, difficulty in adjusting a thickness of the same, and so on. Therefore, the Ag paste has largely been replaced by an adhesive film.

An adhesive film for semiconductor assembly is generally used in combination with a dicing film. The dicing film is a film for fixing a semiconductor wafer during a dicing process among a series of processes for manufacture of semiconductor chips. The dicing process is typically followed by subsequent processes such as expanding, pickup (or lift off), or mounting. Such a dicing film is generally formed by applying a UV curable or other curable adhesive to a base film having a polyvinyl chloride or polyolefin based structure, and laminating a PET based cover film on the coated film. A conventional use of an adhesive film for semiconductor assembly is as follows: the adhesive film is attached to a semiconductor wafer; a dicing film having a structure described above and another dicing film, from which a cover film is removed, are applied overlapping each other to the above wafer laminate; and the laminate is subjected to a dicing process for engraving.

At present, there is a growing trend that, after combining a dicing film (without the PET cover film) and an adhesive film, a semiconductor wafer is placed and fixed on the combined film followed by engraving through a dicing process. However, this process must fulfill a difficult task of simultaneously removing a die and a die adhesive film during lift off, and may generate a number of gaps or voids caused by a rough surface while attaching the die adhesive film to a rear side of the semiconductor wafer. If the voids remain in an interface between a chip and a next level substrate, e.g., a die interposer or a printed circuit board, after semiconductor assembly and are exposed to high temperatures, the gaps or voids may undergo volume expansion, which in turn, generates cracks, leading to a decrease in reliability of a semiconductor device and failure thereof. Accordingly, occurrence of voids in the interface between the chip and the next-level substrate in all processes for semiconductor assembly should be minimized.

A typical solution to overcome the above problem increasing the content of a curable resin in the dicing film. However, this approach may induce a decrease in tension strength of the dicing film. This decrease in tension strength may cause burr generation, the film to be cut during pre-cutting, or chipping during sawing in the semiconductor assembly. Additionally, since the dicing film having an inherently low elastic modulus exhibits high adhesion to an adhesive film, the adhesive film is readily deformed, which in turn, is likely to reduce lift off success rate.

For a package including at least two semiconductor chips with the same size, a semiconductor chip having an adhesive film is typically laminated on a lower semiconductor chip having unevenness due to a wire. In this regard, there is a requirement for an adhesive film that ensures insulation between the adhesive film and the upper semiconductor chip while filling uneven portions of the wire to minimize the generation of gaps or voids.

A conventional method for adhering a semiconductor chip to a substrate and inhibiting generation of gaps and voids during the adhesion through structural modification require an additional process or an additional adhesive or additive. A conventional package using an elastomer composition including hydrogenated nitrile rubber (HNBR), which reduces elastic modulus while improving resistance to moisture and oxidation of the package, also requires an additional process or an additional adhesive or additive. The conventional methods and packages have problems associated with the additional processes and adhesives or additives.

### SUMMARY OF THE INVENTION

Embodiments are therefore directed to an adhesive composition for die bonding in semiconductor assembly, an adhesive film including the same, a dicing die-bonding film including the same, a device package including the same, and associated methods, which substantially overcome one or more of the problems due to the limitations and disadvantages of the prior art.

It is therefore a feature of an embodiment to provide an adhesive film composition capable of minimizing gaps or voids.

It is therefore a feature of an embodiment to provide an adhesive film for semiconductor assembly, the adhesive film having a ductile structure and improved tensile strength even with increased content of a curable resin in the film, thereby endowing improved hardness to the film without unwanted cutting thereof.

It is therefore a feature of an embodiment to provide an adhesive film for semiconductor assembly, which may be less brittle before curing, thus preventing contamination due to film debris during sawing or mounting, and which may have the advantage of enabling the film to be easily handled.

It is therefore a feature of an embodiment to provide an adhesive film for semiconductor assembly, which can ensure insulation between the adhesive film and an upper semiconductor chip while filling uneven portions of a wire to minimize the generation of gaps or voids.

At least one of the above and other features and advantages may be realized by providing an adhesive film composition including a polymer binder, a curable resin, and about 40 to about 60 wt. % of solvent, wherein the solvent is a binary solvent consisting essentially of a first solvent with a boiling point of about 40° C. to about 100° C. and a second solvent with a boiling point of about 140° C. to about 200° C.

The polymer binder may include at least one of an acrylic polymer binder, an isocyanate polymer binder, and an epoxy polymer binder, and the curable resin may include at least one of an epoxy curable resin, a phenol curable resin, a urethane curable resin, a silicone curable resin, a polyester curable resin, an amine curable resin, a melamine curable resin, a urea curable resin, and an acid anhydride curable resin.

The composition may further include at least one of a curing catalyst, a coupling agent, and a filler. The polymer binder may include an acrylic polymer, the curable resin may include an epoxy resin and a phenol resin, and the coupling agent may include a silane coupling agent.

The composition may include about 2 to about 50 wt. % of the acrylic polymer binder, about 4 to about 50 wt. % of the epoxy curable resin, about 3 to about 50 wt. % of the phenol curable resin, about 0.01 to about 10 wt. % of the curing catalyst, about 0.01 to about 10 wt. % of the silane coupling agent, and about 0.1 to about 50 wt. % of the filler.

The acrylic polymer binder may include at least one cross-linkable epoxy group having an epoxy equivalent weight of about 1,000 to about 10,000.

A weight ratio of the first solvent to the second solvent may be about 70 to about 400 parts by weight of the second solvent relative to 100 parts by weight of the first solvent.

The first solvent may include at least one of acetone, benzene, methylethylketone, tetrahydrofuran, dimethylformamide, and cyclohexane.

The second solvent may include at least one of propyleneglycol monomethylether acetate and cyclohexanone.

The polymer binder may have a weight average molecular weight of about 100,000 to about 700,000.

The curable resin may include at least about 50 wt. % of at least one multi-functional epoxy group.

The curable resin may include at least about 50 wt. % of at least one phenol novolac curable resin.

At least one of the above and other features and advantages may also be realized by providing an adhesive film for semiconductor assembly fabricated using a composition, the composition including a polymer binder, a curable resin, and solvent, wherein the solvent is a binary solvent consisting essentially of a first solvent with a boiling point of about 40° C. to about 100° C. and a second solvent with a boiling point of about 140° C. to about 200° C., and the adhesive film contains less than about 2 wt. % of the solvent.

The adhesive film may have an elongation of about 150 to about 400%.

The adhesive film may have a storage elastic modulus of about 0.1 to about 10 MPa at 25° C. and another storage elastic modulus of about 0.01 to about 0.10 MPa at 80° C.

The adhesive film may have a melt viscosity at 25° C. of about 1,000,000 to about 5,000,000 P and a surface tacking value of less than about 0.1 gf.

The adhesive film may exhibit less than about 5% volatile voids.

The adhesive film may contain more than zero wt. % of the solvent.

At least one of the above and other features and advantages may also be realized by providing a dicing die-bonding film including a base film, an adhesive layer, and an attachment film layer stacked in sequence. The attachment film layer may include an adhesive film including a polymer binder, a curable resin, and solvent, wherein the solvent is a binary solvent consisting essentially of a first solvent with a boiling point of about 40° C. to about 100° C. and a second solvent with a boiling point of about 140° C. to about 200° C., and the adhesive film contains less than about 2 wt. % of the solvent. The adhesive film may contain more than zero wt. % of the solvent.

At least one of the above and other features and advantages may also be realized by providing a method of forming an adhesive film for semiconductor assembly, the method including providing an adhesive film composition, and forming the adhesive composition into a film shape, the adhesive film composition including a polymer binder, a curable resin, and about 40 to about 60 wt. % of solvent, wherein the solvent is a binary solvent consisting essentially of a first solvent with a boiling point of about 40° C. to about 100° C. and a second solvent with a boiling point of about 140° C. to about 200° C. The method may further include curing the adhesive film composition at about 120° C. to about 150° C. for about 1 to about 10 hours.

At least one of the above and other features and advantages may also be realized by providing a device package, including a die, an attachment film, and a next-level substrate, wherein the die is bonded to the next-level substrate by the attachment film, and the attachment film includes the adhesive film according to an embodiment.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1. illustrates Formulae 1 through 3;

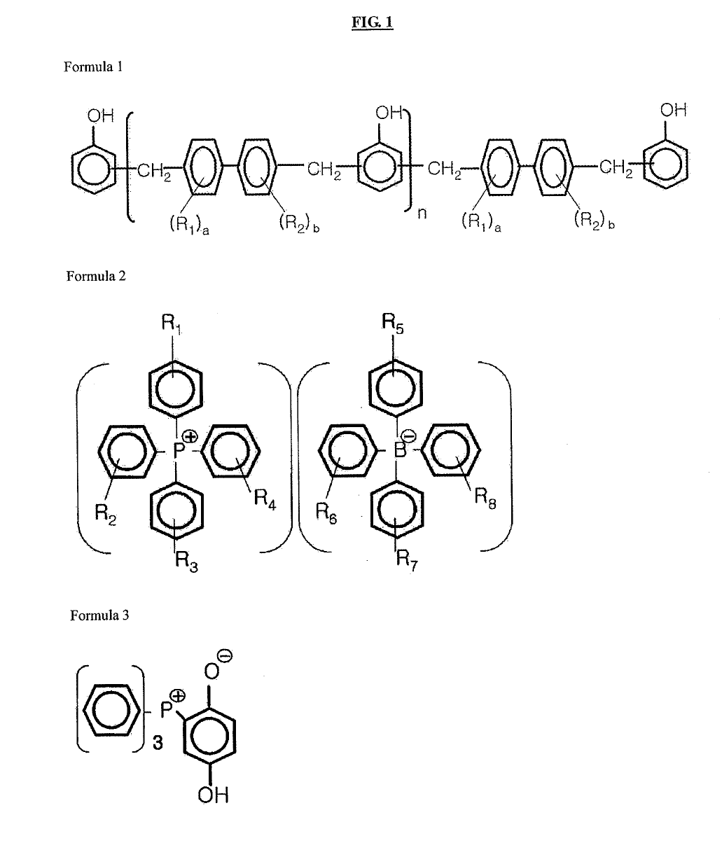

FIG. 2 illustrates Table 1 listing film processing ability and surface conditions of films obtained from the experiments;

FIG. 3 illustrates Table 2 listing measurement results of films obtained from the experiments;

FIG. 4 illustrates Table 3 listing physical properties of films obtained from the experiments; and

FIG. 5 illustrates a device package including a die bonded to a substrate using an attachment film according to an embodiment.

### DETAILED DESCRIPTION OF THE INVENTION

Korean Patent Application No. 10-2007-0122101, filed on Nov. 28, 2007, in the Korean Intellectual Property Office, and entitled: “Adhesive Composition for Die Bonding in Semiconductor Assembly with High Boiling Point Solvent and Low Boiling Point Solvent and Adhesive Film Prepared Therefrom,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of.” For example, the expression “at least one of A, B, and C” may also include an nth member, where n is greater than 3, whereas the expression “at least one selected from the group consisting of A, B, and C” does not.

As used herein, the expression “or” is not an “exclusive or” unless it is used in conjunction with the term “either.” For example, the expression “A, B, or C” includes A alone; B alone; C alone; both A and B together; both A and C together; both B and C together; and all three of A, B, and C together, whereas the expression “either A, B, or C” means one of A alone, B alone, and C alone, and does not mean any of both A and B together; both A and C together; both B and C together; and all three of A, B, and C together.

As used herein, the terms “a” and “an” are open terms that may be used in conjunction with singular items or with plural items. For example, the term “a curing catalyst” may represent a single compound, e.g., triphenylphosphine, or multiple compounds in combination, e.g., triphenylphosphine mixed with triphenylphosphine 1,4-benzoquinone.

As used herein, molecular weights of polymeric materials are weight average molecular weights, unless otherwise indicated.

As used herein, the term “weight parts” refers to a unit of weight measurement, e.g., grams (g), kilograms (kg), ounces (oz), pounds (lb), etc. For example, where a composition is composed of 60 weight parts of component A and 70 weight parts of component B, the composition may have a total weight of 130 g., 130 kg, 130 oz, 130 lb, etc.

It is to be understood that, although the terms first, second, third, and the like may be used herein to describe various elements, components, regions, layers, and sections, these elements, components, regions, layers, and sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present invention.

An embodiment provides an adhesive film composition including a polymer binder, a curable resin, and a solvent, wherein the solvent is a two-component solvent herein, a “binary solvent” including a first solvent with a boiling point of about 40° C. to about 100° C. and a second solvent with a boiling point of about 140° C. to about 200° C.

The polymer binder may include at least one of an acrylic polymer binder, an isocyanate polymer binder, and an epoxy polymer binder.

The curable resin may include at least one of an epoxy curable resin, a urethane curable resin, a silicone curable resin, a polyester curable resin, a phenol curable resin, an amine curable resin, a melamine curable resin, a urea curable resin, and an acid anhydride curable resin.

The composition may further include at least one of a curing catalyst, a coupling agent, and a filler.

Preferably, the composition includes an acrylic polymer binder, an epoxy curable resin, a phenol curable resin, the binary solvent, a curing catalyst, a silane coupling agent, and a filler.

The composition may include about 2 to about 50% by weight (“wt. %”) of the acrylic polymer binder, about 4 to about 50 wt. % of the epoxy curable resin, about 3 to about 50 wt. % of the phenol curable resin, about 40 to about 60 wt. % of the binary solvent, about 0.01 to about 10 wt. % of the curing catalyst, about 0.01 to about 10 wt. % of the silane coupling agent, and about 0.1 to about 50 wt. % of the filler.

Binary Solvent

The adhesive composition for semiconductor assembly preferably includes a binary organic solvent. The organic solvent may be effective to reduce a viscosity of the composition sufficient to easily fabricate an adhesive film. Since the organic solvent may influence physical properties of the adhesive film, fabricated using the composition, depending on a thickness of the film, the adhesive film may contain a solvent residue of less than about 2%. The binary solvent may include a first solvent and a second solvent. Binary solvent remaining in the film may reinforce a ductile structure of an adhesive film by a small residue of the binary solvent, i.e., a small residue of each of the first and second solvents, that remains after fabricating the film, thus alleviating unwanted cutting of the film.

The first solvent may be an organic solvent having a boiling point of about 0° C. to about 110° C., and preferably, about 40° C. to about 100° C. The second solvent may be an organic solvent having a boiling point of about 130° C. to about 300° C., and preferably, about 140° C. to about 200° C.

Preferably, the binary solvent consists essentially of the first solvent and the second solvent. The solvent combination of the first and second solvent helps reduce an extent of voids generated due to volatilization (“volatile voids”) depending on processing temperatures, thereby reducing laminate voids. As explained in detail below, the binary solvent consisting essentially of the first solvent and the second solvent helps ensure that air bubbles are not generated on a surface of the film and helps ensure that the amount of the solvent residue in the resulting film is less than 2%, ensuring reliability of the film.

The first solvent may include at least one of benzene, acetone, methylethylketone, tetrahydrofuran, dimethylformamide (DMF), and cyclohexane.

The second solvent may include at least one of propyleneglycol monomethylether acetate and cyclohexanone.

When using two or more first solvents, an amount of the solvent residue is preferably controlled depending on a drying temperature. Such first solvent having a suitable drying temperature may include at least one of benzene, methylethylketone, and cyclohexane.

The binary solvent may include about 70 to about 400 parts by weight (“wt. parts”) of the second solvent relative to 100 wt. parts of the first solvent, and preferably, about 100 to about 230 wt. parts of the second solvent. Maintaining the amount of the second solvent at about 70 wt. parts or more may help ensure that air bubbles are not generated on a surface of the film. Maintaining the amount of the second solvent at about 400 wt. parts or less may help ensure that the amount of the solvent residue in the resulting film is less than 2%, ensuring reliability of the film.

The composition may contain the binary solvent in an amount of about 40 to about 60 wt. % of the total weight of the composition. Maintaining the amount of the binary solvent at about 60 wt. % or less may help ensure that a viscosity of the composition is not too low to have a regular thickness of the film and that a flow mark of the composition does not remain on a surface of the film. Maintaining the amount of the binary solvent at about 40 wt. % or more may help ensure solubility of the composition, ease of obtaining uniform constitutional ratios of the composition, and ease of fabricating an adhesive film.

The binary solvent containing the second solvent may serve to alleviate generation of voids during fabrication of the adhesive film. Boiling the binary solvent generates air bubbles and, if a liquid around the air bubbles is enclosed by a relatively low volatility ingredient or by a high boiling point solvent, a driving force for heat transfer to grow the air bubbles may be reduced, which in turn, may decrease a difference in temperatures of an interface between a semiconductor die and an adhesive film, thereby reducing the generation of air bubbles and decreasing voids in the interface. If the adhesive film fabricated using the composition is cured, the film may be less than about 5% volatile voids.

Polymer Binder

The polymer binder may include at least one of an acrylic polymer binder, an isocyanate polymer binder, and an epoxy polymer binder.

The polymer binder is preferably an acrylic polymer binder. The acrylic polymer binder is preferably a rubber component to fabricate a film, may include hydroxyl, carboxyl, or epoxy groups, and, preferably, is an adhesive polymer resin containing an epoxy group.

The acrylic polymer binder may have a glass transition temperature or a molecular weight that is readily controlled depending on selection of monomers for polymerization and, especially, may have an advantage of easily introducing a functional group to a side chain. The monomer used in copolymerization may include acrylonitrile, butyl acrylate, butyl methacrylate, 2-ethylhexyl acrylate, acrylic acid, 2-hydroxyethyl(meth)acrylate, methyl(meth)acrylate, styrene monomer, glycidyl(meth)acrylate, isooctylacrylate, and stearylmethacrylate.

The acrylic polymer binder may be classified based on epoxy equivalent weight, glass transition temperature, or molecular weight. An example of commercially available products with an epoxy equivalent weight above 10,000 may include SG-80H, while SG-P3 series and SG-800H series products have an epoxy equivalent weight of less than 10,000, all of which are manufactured by Nagase ChemteX Corp.

The acrylic polymer binder preferably has a glass transition temperature (Tg) of about 0° C. to about 30° C. This may help prevent brittleness of a film at room temperature or inhibit burr generation or occurrence of chipping during sawing in the manufacture of a semiconductor.

The acrylic polymer binder used herein may have at least one cross-linkable functional group having an epoxy equivalent weight of about 1,000 to about 10,000. Preferably, the epoxy equivalent weight is about 2,000 to about 3,000. Maintaining the epoxy equivalent weight at about 1,000 or more may help ensure the ability to form a film. Maintaining the epoxy equivalent weight at about 10,000 or less may help ensure the compatibility of the functional group with an epoxy or phenol, maintaining the reliability of the film.

The acrylic polymer binder may have a molecular weight of about 100,000 to about 700,000.

The content of the acrylic polymer binder in the adhesive composition for semiconductor assembly may be about 2 to about 50 wt. % of total weight of the composition and, more preferably, about 2 to about 25 wt. %. Maintaining the weight percent at about 2 wt. % or more may help ease the forming of a film. Maintaining the weight percent at about 50 wt. % or less may help ensure reliability of the film.

Curable Resin

Epoxy Curable Resin

An epoxy curable resin used in preferred embodiments may include an epoxy curable resin having a high cross-linking density to impart strong curing and adhesive effects. However, since a single curable epoxy system with a high cross-linking density may result in a brittle film, the epoxy curable resin preferably includes a liquid-like epoxy curable resin, or a combination of mono- and/or di-functional epoxy curable resins, which have minimum cross-linking densities.

The epoxy curable resin may have an equivalent weight of about 100 to about 1,500 g/eq., more preferably about 150 to about 800 g/eq. and, most preferably about 150 to about 400 g/eq. Maintaining the epoxy equivalent weight at about 100 g/eq. or more may help ensure that the cured substance maintains adhesiveness. Maintaining the epoxy equivalent weight at about 1,500 g/eq. or less may help prevent a decrease in glass transition temperature or deterioration in thermal resistance of the epoxy curable resin.

The epoxy curable resin may preferably include at least one of a bisphenol epoxy curable resin, an ortho-cresol novolac epoxy curable resin, a multi-functional epoxy curable resin, an amine epoxy curable resin, a heterocyclic epoxy curable resin, a substitutional epoxy curable resin, and a naphthol epoxy curable resin. The bisphenol epoxy curable resin may include: Epiclon 830-S, Epiclon EXA-830CRP, Epiclon EXA 850-S, Epiclon EXA-835LV, etc., provided by Dainippon Ink and Chemicals, Inc.; Epicoat 807, Epicoat 815, Epicoat 825, Epicoat 827, Epicoat 828, Epicoat 834, Epicoat 1001, Epicoat 1004, Epicoat 1007, Epicoat 1009, etc., provided by Yuka Shell Epoxy Co., Ltd.; DER-330, DER-301, DER-361, etc., provided by Dow Chemical Co., and YD-128 or YDF-179 provided by Kukdo Chemical Co., Ltd. The ortho-cresol novolac epoxy curable resin may include YDCN-500-1P, YDCN-500-4P, YDCN-500-5P, YDCN-500-7P, YDCN-500-80P, YDCN-500-90P, etc., provided by Kukdo Chemical Co., Ltd.; or EOCN-102S, EOCN-103S, EOCN-1045, EOCN-1012, EOCN-1025, EOCN-1027, etc., provided by Nippon Kayaku Co., Ltd. The multifunctional epoxy curable resin may include Epon 1031S provided by Yuka Shell Epoxy Co., Ltd., Araldite 0163 provided by Ciba Specialty Chemicals, and Detachol EX-611, Detachol EX-614, Detachol EX-614B, Detachol EX-622, Detachol EX-512, Detachol Ex-521, Detachol Ex-421, Detachol EX-411, Detachol EX-321, etc., provided by NAGA Celsius Temperature Co., Ltd. The amine epoxy curable resin may include Epicoat 604 provided by Yuka Shell Epoxy Co., Ltd., YH-434 provided by Kukdo Chemical Co., Ltd.; TETRAD-X or TETRAD-C provided by Mitsubishi Gas Chemical Company Inc., and ELM-120 provided by Sumitomo Chemical Industry Co., Ltd. The heterocyclic epoxy curable resin may include PT-810 provided by Ciba Specialty Chemicals. The substitutional epoxy curable resin may include ERL-4234, ERL-4299, ERL-4221, ERL-4206, etc., provided by UCC Co., Ltd. The naphthol epoxy curable resin may include Epiclon HP-4032, Epiclon HP-4032D, Epiclon HP-4700, Epiclon HP-4701, etc., provided by Dainippon Ink and Chemicals, Inc.

The epoxy curable resin may include at least about 50 wt. % of a multifunctional epoxy curable resin. Maintaining the content of the multifunctional epoxy curable resin at about 50 wt. % or more may help ensure that the epoxy resin has a higher cross-linking density, thus increasing internal bonding strength of a structure and maintaining reliability.

The epoxy curable resin content may be about 4 to about 50 wt. % of total weight of the adhesive composition, and preferably about 4 to about 35 wt. %. Maintaining the content at about 4 wt. % or more may help ensure that the adhesive film has enough curable resin portions, thereby maintaining reliability. Maintaining the content at about 50 wt. % or less may help ensure compatibility of the adhesive film. Maintaining the content of the epoxy curable resin at about 35 wt. % or less may help ensure reduced surface tacking properties of the adhesive film at room temperature, which, in turn, may decrease adhesion between the film and an adhesive during re-work.

Phenol Curable Resin

The phenol curable resin preferably includes at least one of a bisphenol A, F and S phenol curable resin, compounds having at least two phenolic hydroxyl groups in one molecule. These resins have excellent electrolytic corrosion resistance to moisture absorption. The phenol curable resin may also be another phenol curable resin such as a phenol novolac curable resin, a bisphenol A novolac curable resin, a cresol novolac curable resin, a xyloc curable resin, or a biphenyl curable resin.

Preferred phenol curable resins may include: H-1, H-4, HF-1M, HF-3M, HF-4M, HF-45, etc., provided by Meiwa Kasei Co., Ltd., as a simple phenol resin; MEH-780045, MEF-7800SS, MEH-7800S, MEH-7800M, MEH-7800H, MEH-7800HH, MEH-78003H, etc., provided by Meiwa Kasei Co., Ltd., as a para-xylene curable resin; KPH-F3065 provided by KOLON Chemical Co., Ltd.; MEH-7851SS, MEH-7851S, MEH-7851M, MEH-7851H, MEH-78513H, MEH-78514H, etc., provided by Meiwa Kasei Co., Ltd., as a biphenyl curable resin; KPH-F4500 provided by KOLON Chemical Co., Ltd.; and MEH-7500, MEH-750035, MEH-7500SS, MEH-7500H, etc., provided by Meiwa Kasei Co., Ltd., as a triphenylmethyl curable resin.

The phenol curable resin is preferably represented by the following Formula 1:

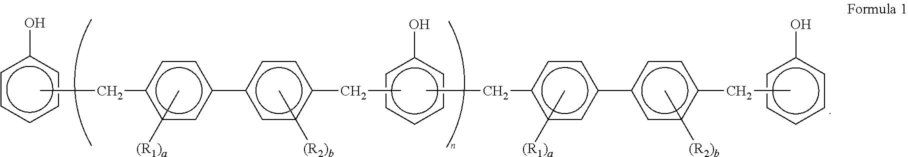

In Formula 1, R₁ and R₂ may each independently be a hydrogen atom or an alkyl group having 1 to 4 carbon atoms; a and b may each independently be an integer ranging from 0 to 4; and n may be an integer ranging from 0 to 7.

The phenol curable resin represented by Formula 1 may be a compound having at least two hydroxyl groups in one molecule and may have excellent electrolytic corrosion resistance to moisture absorption, superior thermal resistance, and low moisture absorption, thereby exhibiting excellent reflow resistance.

The phenol curable resin represented by Formula 1 preferably has a hydroxyl equivalent weight of about 100 to about 600 g/eq., more preferably about 170 to about 300 g/eq. Maintaining the hydroxyl equivalent weight at about 100 g/eq. or more may help ensure that the resin has less moisture absorption and lower deterioration of the reflow resistance. Maintaining the hydroxyl equivalent weight at about 600 g/eq. or less may help ensure that the glass transition temperature does not decrease and the thermal resistance does not deteriorate.

Maintaining the phenol curable resin at about 50 wt. % or more of a phenol novolac curable resin may help ensure that the curable resin has an increased cross-linking density after curing to increase intermolecular cohesion, which, in turn, increases internal bonding strength, thereby improving adhesiveness of the composition. Furthermore, maintaining the phenol novolac curable resin content in the phenol curable resin at about 50 wt. % or more may help ensure minimal deformation due to external stress, thereby maintaining a constant thickness of the film.

The phenol curable resin used herein may be added in an amount of about 3 to about 50 wt. %, and preferably, about 3 to about 30 wt. % of total weight of the adhesive composition.

Curing Catalyst

A curing catalyst is an additive that may control a curing rate. The curing catalyst may include at least one of a phosphine curing catalyst, a boron curing catalyst, and an imidazole curing catalyst.

The phosphine curing catalyst may include at least one of triphenylphosphine; tri-o-tolylphosphine; tri-m-tolylphosphine; tri-p-tolylphosphine; tri-2,4-xylylphosphine; tri-2,5-xylylphosphine; tri-3,5-xylylphosphine; tribenzylphosphine; tris(p-methoxylphenyl)phosphine; tris(p-tert-butoxyphenyl)phosphine; diphenylcyclohexylphosphine; tricyclohexylphosphine; tricyclophosphine; tributylphosphine; tri-tert-butylphosphine; tri-n-octylphosphine; diphenylphosphinostyrene; diphenylphosphinous chloride; tri-n-octylphosphine oxide; diphenylphosphinyl hydroquinone; tetrabutylphosphonium hydroxide; tetrabutylphosphonium acetate; benzyltriphenylphosphonium hexafluoroantimonate; tetraphenylphosphonium tetraphenylborate; tetraphenylphosphonium tetra-p-tolylborate; benzyltriphenylphosphonium tetraphenylborate; tetraphenylphosphonium tetrafluoroborate; p-tolyltriphenylphosphonium tetra-p-tolylborate; triphenylphosphine triphenylborane; 1,2-bis(diphenylphosphino)ethane; 1,3-bs(diphenylphosphino)propane; 1,4-bis(diphenylphosphino)butane; and 1,5-bis(diphenylphosphino)pentane.

The boron curing catalyst may include at least one of phenyl boronic acid; 4-methylphenyl boronic acid; 4-methoxyphenyl boronic acid; 4-methoxyphenyl boronic acid; 4-trifluoromethoxyphenyl boronic acid; 4-tert-butoxyphenyl boronic acid; 3-fluoro-4-methoxyphenyl boronic acid; pyridine-triphenylborane; 2-ethyl-4-methylimidazolium tetraphenylborate; 1,8-diazabicyclo[5.4.0]undecene-7-tetraphenylborate; 1,5-diazabicyclo[4.3.0]nonene-5-tetraphenylborate; and lithium triphenyl(n-butyl)borate.

The imidazole curing catalyst may include at least one of 2-methylimidazole; 2-undecylimidazole; 2-heptadecylimidazole; 2-ethyl-4-methylimidazole; 2-phenylimidazole; 2-phenyl-4-methylimidazole; 1-benzyl-2-phenylimidazole; 1,2-dimethylimidazole; 1-cyanoethyl-2-methylimidazole; 1-cyanoethyl-2-ethyl-4-metylimidazole; 1-cyanoethyl-2-undecylimidazole; 1-cyanoethyl-2-phenylimidazole; 1-cyanoethyl-2-undecylimidazolium-trimellitate; 1-cyanoethyl-2-phenylimidazolium-trimellitate; 2,4-diamino-6[2′-methylimidazoyl-(1′)]-ethyl-s-triazine; 2,4-diamino-6-[2′-undecylimidazoyl-(1′)]-ethyl-s-triazine; 2,4-diamino-6-[2′-methylimidazoyl-(l1′)]-ethyl-s-triazine isocyanuric acid adduct dehydrate; 2-phenylimidazole isocyanuric acid adduct; 2-methylimidazole isocyanuric acid adduct dehydrate; 2-phenyl-4,5-dihydroxymethylimidazole; 2-phenyl-4-methyl-5-hydroxymethylimidazole; 2,3-dihydro-1H-pyrrolo[1,2-a]benzimidazole; 4,4′-methylene bis(2-ethyl-5-methylimidazole), 2-methylimidazoline; 2-phenylimidazoline; 2,4-diamino-6-vinyl-1,3,5-triazine; 2,4-diamino-6-vinyl-1,3,5-triazine isocyanuric acid adduct; 2,4-diamino-6-methacryloyloxyethyl-1,3,5-triazine isocyanuric acid adduct; 1-(2-cyanoethyl)-2-ethyl-4-methylimidazole; 1-cyanoethyl-2-methylimidazole; 1-(2-cyanoethyl)2-phenyl-4,5-di-(cyanoethoxymethyl)imidazole; 1-acetyl-2-phenylhydrazine; 2-ethyl-4-methyl imidazoline; 2-benyl-4-methyl dimidazoline; 2-ethylimidazoline; 2-phenylimidazole; 2-phenyl-4,5-dihydroxymethylimidazole; melamine; and dicyandiamide.

The curing catalysts may each be used alone, or as a combination of two or more thereof.

The curing catalyst may include a compound represented by at least one of Formulae 2 and 3:

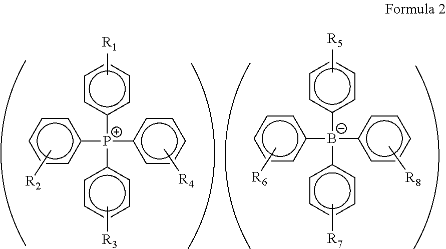

In Formula 2, R₁ to R₈ may each independently be a hydrogen atom, a halogen atom, or an alkyl group.

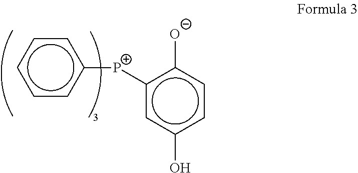

The curing catalyst represented by any one of Formulae 2 and 3 may have a higher initiating temperature for a curing reaction than that of an amine curing agent or an imidazole curing catalyst, may be useful for attaining a uniform curing rate, and may show a relatively low reactivity at room temperature, therefore, favorably ensuring excellent storage effects. In a preferred embodiment, adding a curing catalyst represented by Formula 2 or 3 to a phenol curable resin represented by Formula 1 may inhibit a curing reaction from progressing at room temperature so that failure in the semiconductor assembly caused by irregular curing properties may be reduced. Furthermore, the adhesive composition including the curing catalyst represented by Formula 2 or 3 may exhibit a relatively low electrical conductivity compared to an adhesive composition containing an amine curing catalyst or an imidazole curing catalyst, resulting in excellent reliability during a “Pressure Cooker Test (PCT).”

The curing catalyst may be added in an amount of about 0.01 to about 10 wt. % of the total weight of the adhesive composition for semiconductor assembly. Preferably, the amount of the curing catalyst is about 0.01 to about 2 wt. % of the total weight of the adhesive composition. Maintaining the amount of the curing catalyst at about 10 wt. % or less may help ensure that the storage stability of the composition is not deteriorated.

Coupling Agent

The coupling agent is preferably a silane coupling agent. The silane coupling agent added to the composition may increase adhesion between a surface of an inorganic material such as silica and a resin in an adhesive film. The silane coupling agent may include any suitable silane coupling agent commonly used in the related art. The silane coupling agent used herein may include at least one of an epoxy group containing silane coupling agent, an amine group containing silane coupling agent, an isocyanate containing silane coupling agent, and a mercapto group containing silane coupling agent. The epoxy group containing silane coupling agent preferably includes at least one of 2-(3,4-epoxycyclohexyl)-ethyltrimethoxysilane, 3-glycidoxytrimethoxysilane, and 3-glycidoxypropyl triethoxysilane. The amine group containing silane coupling agent preferably includes at least one of N-2(aminoethyl)-3-aminopropyl trimethoxysilane, N-2(aminoethyl)-3-aminopropyl trimethoxysilane, N-2(aminoethyl)-3-aminopropyl triethoxysilane, 3-aminopropyltrimethoxylsilane, 3-aminopropyltriethoxylsilane, 3-triethoylsili-(1,3-dimethylbutylidene)propylamine, and N-phenyl-3-aminopropyltrimethoxysilane. The mercapto group containing silane coupling agent preferably includes at least one of 3-mercaptopropylmethyl dimethoxysilane and 3-mercaptopropyltrietoxylsilane. The isocyanate containing silane coupling agent is preferably 3-isocyanate propyltriethoxysilane.

The silane coupling agent may be added in an amount of about 0.01 to about 10 wt. % of the total weight of the adhesive composition.

Filler

The composition may further include any suitable filler so as to exhibit thixotropic properties, thus having a controlled melt viscosity. The filler may include at least one of an inorganic and an organic filler. The inorganic filler may include at least one metallic component which may include at least one of silver, copper, and nickel in a powder state. The inorganic filler may include at least one inorganic component which may include at least one of alumina, aluminum hydroxide, magnesium hydroxide, calcium carbonate, magnesium carbonate, calcium silicate, magnesium silicate, calcium oxide, magnesium oxide, aluminum oxide, aluminum nitride, silica, boron nitride, titanium dioxide, glass, ferrite, and ceramic. The organic filler may include at least one of carbon filler, rubber filler, and polymer based filler. The filler may have a spherical surface with hydrophobic properties.

Spherical silica particles may be used herein as the filler, and preferably have a particle size of about 500 nm to about 10 μm. Maintaining the particle size of the inorganic filler at about 10 μm or less may help ensure that the particle does not collide with a semiconductor circuit, causing damage to the circuit.

The amount of the filler is preferably about 0.1 to about 50 wt. % of the total weight of the adhesive composition. Maintaining the amount of filler at about 50 wt. % or less may help ensure the ability to form an adhesive film, and avoid deterioration in tensile strength of the film. If the adhesive film is used as a die adhesive film, the amount of the filler is preferably about 10 to about 40 wt. %.

In another embodiment, there is provided an adhesive film for semiconductor assembly fabricated using the composition including the polymer binder, the curable resin, and the solvent, wherein the solvent is the binary solvent, including the first solvent with a boiling point of about 40° C. to about 100° C. and the second solvent with a boiling point of about 140° C. to about 200° C., which contains less than about 2% solvent residue.

The adhesive film may be dried at about 80° C. to about 120° C. for about 10 to about 60 minutes.

The drying temperature or drying time is preferably regulated such that a residue of the low boiling point first solvent may be removed from the adhesive film, and a content of the high boiling point second solvent in the adhesive film may be controlled to less than about 2%.

The adhesive film may be cured at about 120° C. to about 150° C. for about 1 to about 10 hours.

The curing may be performed using a combined process that may include first curing the adhesive film at about 120° C. to about 130° C. for about 1 to about 3 hours, then second curing the first cured adhesive film at about 130° C. to about 150° C. for about 10 to about 60 minutes. The combined process may be repeated once to about eight times. A volatile foaming level caused by the solvent residue may be defined according to the combined curing process.

In consideration of species and contents of the solvent residue in the composition and other physical properties of the composition, a possibility for volatilization of the solvent residue may be controlled during the combined curing process.

Minimizing the content of the second solvent in the solvent residue in the film may considerably reduce voids generated due to volatile components, which may occur in a die-attaching process, and alleviate volume expansion of air bubbles generated in the process.

When using only a solvent having a boiling point lower than a curing temperature of about 125° C., the volatile voids may be generated by a solvent residue during curing. When a solvent having a boiling point of at least about 200° C. is used, the solvent residue may remain in an amount of about 2% or more in the film and may cause volume expansion during EMC molding or evaluation of a reliability of the film, leading to a decrease in reliability of the film.

The second solvent at a desired content may inhibit volume expansion of gaps or voids generated in an interface between a semiconductor die and an adhesive film, which in turn, may minimize the voids and, at the same time, may inhibit volume expansion caused by gaps or voids generated during filling of a wire, thereby fabricating the adhesive film for semiconductor assembly with high reliability. Also, the composition may be effective to reduce brittleness of the adhesive film before curing, thus preventing contamination due to film debris during sawing or mounting, and may have the advantage of enabling the film to be easily handled.

The amount of solvent residue in the adhesive film may be less than about 2%. Accordingly, the adhesive film may contain a solid film portion of at least about 98%. Maintaining the amount of the solid film portion at about 98% or more may help ensure the reliability of the adhesive film by suppressing the foaming or moisture absorption properties of the solvent residue.

The adhesive film may have an elongation of about 150 to about 400%.

The adhesive film may have storage modulus of about 0.1 to about 10 MPa at 25° C. and about 0.01 to about 0.10 MPa at 80° C., a melt viscosity at 25° C. of about 1,000,000 to about 5,000,000 P, and a surface tacking value of less than about 0.1 gf. Since the solvent residue contained in the film may not affect the viscosity or the surface tacking properties of the composition, the adhesive film may have little influence on physical properties required for semiconductor assembly. That is, a storage elastic modulus, fluidity, or surface tacking properties of an adhesive before curing may be kept consistent without variation caused by the second solvent. Consequently, the second solvent may not affect storage of the adhesive film at room temperature.

Because the adhesive film according to a preferred embodiment may have volatilization speed and volatile amount at about 125° C. to about 175° C., which are smaller than those of a film fabricated using only a first solvent, the adhesive film according to a preferred embodiment may have a ductile structure to prevent brittleness of the film. Further, the adhesive film may exhibit an effect of inhibiting generation of voids so as to minimize lamination voids generated in semiconductor assembly to less than about 5%.

Another embodiment provides a dicing die-bonding film which may include a base film, an adhesive layer, and an attachment film layer laminated on the base film, in this order. The attachment film layer may substantially be formed using the adhesive film including the polymer binder, the curable resin, and the solvent, wherein the solvent is a binary solvent including the first solvent with a boiling point of about 40° C. to about 100° C. and the second solvent with a boiling point of about 140° C. to about 200° C., which contains less than about 2% solvent residue.

The adhesive layer of the dicing die-bonding film may be formed using any suitable adhesive composition and, preferably, includes about 100 weight parts (“wt. parts”) of at least one polymer binder, about 20 to about 150 wt. parts of at least one UV curable acrylate relative to weight of the polymer binder, and about 0.1 to about 5 wt. parts of at least one photo initiator relative to weight of the UV curable acrylate.

The base film of the dicing die-bonding film may exhibit radiation transmission or radiolucent properties. If a radiation curable adhesive reacting based on UV irradiation is applied, the base film may be prepared using at least one polymeric material exhibiting favorable light transmission. These polymeric materials may include at least one of a polyolefin homopolymer or copolymer such as polyethylene, a polypropylene, a propylene ethylene copolymer, an ethylene ethyl acrylate copolymer, an ethylene methyl acrylate copolymer, and an ethylene vinyl acetate copolymer, etc.; a polycarbonate; a polymethyl methacrylate; a polyvinyl chloride; a polyurethane copolymer, and the like. The base film preferably has a thickness of about 50 to about 200 μm in consideration of at least tensile strength, elongation, and radiolucent properties.

The following Examples and Comparative Examples are provided in order to set forth particular details of one or more embodiments. However, it will be understood that the embodiments are not limited to the particular details described.

### EXAMPLES 1 AND 2, COMPARATIVE EXAMPLES 1 TO 5

After adding the following components to a 1 L cylindrical flask equipped with a high speed impeller, the mixture was dispersed under low speed agitation at 3000 rpm for 20 minutes then high speed agitation at 4000 rpm for 5 minutes to prepare a composition. The composition was filtered using a capsule filter with a size of 50 μm and was then applied to a base film using an applicator to fabricate an adhesive film with a thickness of 60 μm. After drying the fabricated film at 80° C. for 20 minutes then at 90° C. for 20 minutes, the completed film was stored at room temperature for 1 day.

### EXAMPLE 1

a) high boiling point second solvent: propyleneglycol monomethylether acetate (PGMEA), b.p. 145° C., manufactured by Sam Chun Pure Co., Ltd., 252 g; and low boiling point first solvent: cyclohexane, b.p. 80° C., manufactured by Sam Chun Pure Co., Ltd., 108 g;

b) epoxy containing acrylic polymer binder: KLS-104a (EEW=2,000 to 3,000), manufactured by Fujikura Kasei Co., Ltd., 220 g;

c) multi-functional epoxy curable resin: EP-5100R, manufactured by Kukdo Chemical Co., Ltd., 80 g;

d) phenol novolac curable resin: DL-92, manufactured by Meiwa Plastic Industries, Ltd., 60 g;

e) phosphine based curing catalyst: TPP-K, TPP or TPP-MK, manufactured by Meiwa Plastic Industries, Ltd., 3.8 g;

f) epoxy silane coupling agent: KBM-303, manufactured by Shin-Etsu Chemical Co., Ltd., 2.2 g; and

g) spherical silica: SC-4500SQ, SC-2500SQ, manufactured by Admatechs Co., Ltd., 70 g.

### EXAMPLE 2

a) high boiling point second solvent: propyleneglycol monomethylether acetate (PGMEA), manufactured by Sam Chun Pure Co., Ltd., 252 g; and low boiling point first solvent: cyclohexane, manufactured by Sam Chun Pure Co., Ltd., 108 g;

b) epoxy containing acrylic polymer binder: KLS-104a, manufactured by Fujikura Kasei Co., Ltd., 220 g;

c) multi-functional epoxy curable resin: EP-5100R, manufactured by Kukdo Chemical Co., Ltd., 60 g; and bisphenol F epoxy curable resin: YDF 2001, manufactured by Kukdo Chemical Co., Ltd., 20 g;

d) phenol novolac curable resin: DL-92, manufactured by Meiwa Plastic Industries, Ltd., 60 g;

e) phosphine based curing catalyst: TPP-K, TPP or TPP-MK, manufactured by Meiwa Plastic Industries, Ltd., 3.8 g;

f) epoxy silane coupling agent: KBM-303, manufactured by Shin-Etsu Chemical Co., Ltd., 2.2 g; and

g) spherical silica: SC-4500SQ, SC-2500SQ, manufactured by Admatechs Co., Ltd., 70 g.

Comparative Example 1 was performed to investigate an adhesive film containing a binary solvent in an amount of 60% of the composition. Comparative Examples 2 and 3 were performed to investigate viability of an adhesive film with respect to constitutional ratio of the binary solvent and characteristics of the film with respect to solvent residue. Only using a high boiling point solvent in Comparative Example 2 resulted in voids and the measurement results were compared to those of Examples 1 and 2 with respect to reliability and stability of the film. Comparative Example 3 was performed using only a low boiling point solvent without the high boiling point solvent. In Comparative Example 3, the minimum volatile residue was determined and a surface condition of the film was observed using a combined low boiling point solvent system. Comparative Example 4 was performed using a binary solvent including a low boiling point solvent (with b.p. 40° C. to 100° C.) and a moderate boiling point solvent (with b.p. 120° C. to 140° C.) with no high boiling point solvent. Volatile voids or gaps and/or void expansion determined in Comparative Example 4 were compared to those of Examples 1 and 2. Lastly, Comparative Example 5 was performed using a three-component solvent system (that is, a ternary solvent) including three solvents with boiling points in three different regions. In Comparative Example 5, a surface condition of the film and a variation in void content were observed.

### COMPARATIVE EXAMPLE 1

a) high boiling point solvent: propyleneglycol monomethylether acetate

(PGMEA), manufactured by Sam Chun Pure Co., Ltd., 504 g; and low boiling point solvent: cyclohexane, manufactured by Sam Chun Pure Co., Ltd., 216 g;

b) epoxy containing acrylic polymer binder: KLS-104a, manufactured by Fujikura Kasei Co., Ltd., 220 g;

c) multi-functional epoxy curable resin: EP-5100R, manufactured by Kukdo Chemical Co., Ltd., 60 g; and bisphenol F epoxy curable resin: YDF-2001, manufactured by Kukdo Chemical Co., Ltd., 20 g;

d) phenol novolac curable resin: DL-92, manufactured by Meiwa Plastic Industries, Ltd., 60 g;

e) phosphine based curing catalyst: TPP-K, TPP or TPP-MK, manufactured by Meiwa Plastic Industries, Ltd., 3.8 g;

f) epoxy silane coupling agent: KBM-303, manufactured by Shin-Etsu Chemical Co., Ltd., 2.2 g; and

g) spherical silica: SC-4500SQ, SC-2500SQ, manufactured by Admatechs Co., Ltd., 70 g.

### COMPARATIVE EXAMPLE 2

a) high boiling point solvent: propyleneglycol monomethylether acetate (PGMEA), manufactured by Sam Chun Pure Co., Ltd., 360 g;

b) epoxy containing acrylic polymer binder: KLS-104a (EEW=2,000 to 3,000), manufactured by Fujikura Kasei Co., Ltd., 220 g;

c) multi-functional epoxy curable resin: EP-5100R, manufactured by Kukdo Chemical Co., Ltd., 60 g; and bisphenol F epoxy curable resin: YDF-2001, manufactured by Kukdo Chemical Co., Ltd., 20 g;

d) phenol novolac curable resin: DL-92, manufactured by Meiwa Plastic Industries, Ltd., 60 g;

e) phosphine based curing catalyst: TPP-K, TPP or TPP-MK, manufactured by Meiwa Plastic Industries, Ltd., 3.8 g;

f) epoxy silane coupling agent: KBM-303, manufactured by Shin-Etsu Chemical Co., Ltd., 2.2 g; and

g) spherical silica: SC-4500SQ, SC-2500SQ, manufactured by Admatechs Co., Ltd., 70 g.

### COMPARATIVE EXAMPLE 3

a) low boiling point solvent: methylethylketone (MEK), manufactured by Sam Chun Pure Co., Ltd., 252 g; and low boiling point solvent: cyclohexane, manufactured by Sam Chun Pure Co., Ltd., 108 g;

b) epoxy containing acrylic polymer binder: KLS-104a (EEW=2,000 to 3,000), manufactured by Fujikura Kasei Co., Ltd., 220 g;

c) multi-functional epoxy curable resin: EP-5100R, manufactured by Kukdo Chemical Co., Ltd., 60 g; and bisphenol F epoxy curable resin: YDF-2001, manufactured by Kukdo Chemical Co., Ltd., 20 g;

d) phenol novolac curable resin: DL-92, manufactured by Meiwa Plastic Industries, Ltd., 60 g;

e) phosphine based curing catalyst: TPP-K, TPP or TPP-MK, manufactured by Meiwa Plastic Industries, Ltd., 3.8 g;

f) epoxy silane coupling agent: KBM-303, manufactured by Shin-Etsu Chemical Co., Ltd., 2.2 g; and

g) spherical silica: SC-4500SQ, SC-2500SQ, manufactured by Admatechs Co., Ltd., 70 g.

### COMPARATIVE EXAMPLE 4

a) moderate boiling point solvent: methyl iso-butylketone (MIBK), manufactured by Sam Chun Pure Co., Ltd., 252 g; and low boiling point solvent: cyclohexane, manufactured by Sam Chun Pure Co., Ltd., 108 g;

b) epoxy containing acrylic polymer binder: KLS-104a (EEW=2,000 to 3,000), manufactured by Fujikura Kasei Co., Ltd., 220 g;

c) multi-functional epoxy curable resin: EP-5100R, manufactured by Kukdo Chemical Co., Ltd., 60 g; and bisphenol F epoxy curable resin: YDF-2001, manufactured by Kukdo Chemical Co., Ltd., 20 g;

d) phenol novolac curable resin: DL-92, manufactured by Meiwa Plastic Industries, Ltd., 60 g;

e) phosphine based curing catalyst: TPP-K, TPP or TPP-MK, manufactured by Meiwa Plastic Industries, Ltd., 3.8 g;

f) epoxy silane coupling agent: KBM-303, manufactured by Shin-Etsu Chemical Co., Ltd., 2.2 g; and

g) spherical silica: SC-4500SQ, SC-2500SQ, manufactured by Admatechs Co., Ltd., 70 g.

### COMPARATIVE EXAMPLE 5

a) high boiling point solvent: propyleneglycol monomethylether acetate (PGMEA), manufactured by Sam Chun Pure Co., Ltd., 30 g; moderate boiling point solvent: methyl iso-butylketone (MIBK), manufactured by Sam Chun Pure Co., Ltd., 222 g; and low boiling point solvent: cyclohexane, manufactured by Sam Chun Pure Co., Ltd., 108 g;

b) epoxy containing acrylic polymer binder: KLS-104a (EEW=2,000 to 3,000), manufactured by Fujikura Kasei Co., Ltd., 220 g;

c) multi-functional epoxy curable resin: EP-5100R, manufactured by Kukdo Chemical Co., Ltd., 60 g; and bisphenol F epoxy curable resin: YDF-2001, manufactured by Kukdo Chemical Co., Ltd., 20 g;

d) phenol novolac curable resin: DL-92, manufactured by Meiwa Plastic Industries, Ltd., 60 g;

e) phosphine based curing catalyst: TPP-K, TPP or TPP-MK, manufactured by Meiwa Plastic Industries, Ltd., 3.8 g;

f) epoxy silane coupling agent: KBM-303, manufactured by Shin-Etsu Chemical Co., Ltd., 2.2 g; and

g) spherical silica: SC-4500SQ, SC-2500SQ, manufactured by Admatechs Co., Ltd., 70 g.

(1) Film Processing Ability and Surface Conditions of Adhesive Film:

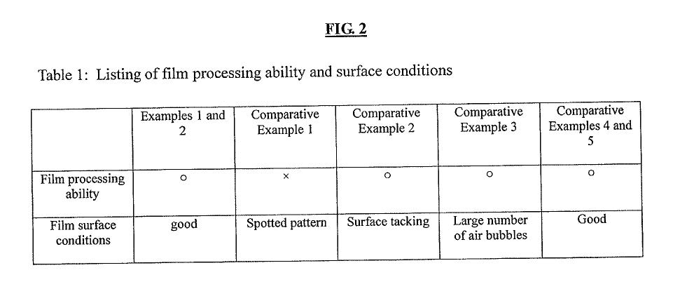

In order to determine film processing ability, that is, film formation, and surface condition of the film, a composition was dried in an oven at 100° C. for 30 minutes. The results of observing the composition to determine whether a film was formed or not and whether air bubbles were generated or not are shown in Table 1 in FIG. 2.

(2) Determination of Volatile Voids:

In order to determine volatile foaming at 125° C. to 150° C., an adhesive film was laminated on a glass plate with a size of 18 mm×18 mm at 60° C., followed by cutting the laminate except an adhesive portion. A PCB substrate with a size of 30 mm×30 mm and having grooves and patterns formed thereon was placed on a hot plate at 100° C. The prepared wafer piece having the adhesive portion was compressed to the substrate at 1.0 kgf for 1.0 second. Appearance of the laminate attached to the substrate was observed by microscopy. Next, the above procedures were repeated at 125° C. for 1 hour and at 150° C. for 10 minutes three times, respectively. Appearance of the laminate was observed by microscopy to determine the presence or absence of volatile foaming to generate voids, where volatile foaming refers to voids produced at 100˜150° C. and volatile voids refers to voides remaining in the film after epoxy molding is finished at a high temperature (more than the 100˜150° C. temperature of the volatile foaming), and both volatile foaming and volatile voids are produced by solvent residue in the film, i.e., volatile foaming results in volatile voids.

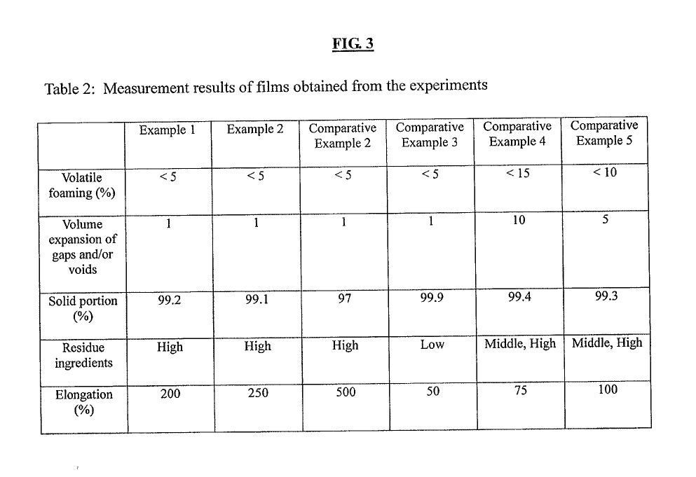

Table 2 shows a degree of volatile foaming by % area. The percentage refers to the area percentage of volatile foaming that results in volatile voids. The higher the area %, the more voids may remain in the film. Surface conditions of the film are also shown in Table 2 in FIG. 3.

(3) Volume Expansion of Gaps and Voids:

In order to determine a volume expansion of gaps and/or voids at 125° C. to 175° C., an adhesive film was laminated on a glass plate with a size of 18 mm×18 mm at 60° C., followed by cutting the laminate except an adhesive portion. A PCB substrate with a size of 30 mm×30 mm and having grooves and patterns formed thereon was placed on a hot plate at 100° C. The prepared wafer piece having the adhesive portion was compressed to the substrate at 1.0 kgf for 1.0 second (such that a part of gaps and/or voids are formed in a middle part of the wafer piece). Appearance of the laminate attached to the substrate having the gaps and/or voids was observed by microscopy. Next, the above procedures were repeated at 125° C. for 1 hour and at 150° C. for 10 minutes three times, respectively. After leaving the wafer piece at 175° C. for 2 hours, volume expansion of the gaps and/or voids was observed by microscopy, followed by calculation of the volume expansion by %. The results are shown in Table 2.

(4) Determination of Solid Portion:

In order to determine an amount of a solvent residue in a film, each film having a weight of 2 g was prepared through lamination. The weight of the film was subjected to zero calibration and, after leaving the film at 170° C. for 10 minutes, a variation in weights of the film was determined. The measurement results are shown in Table 2.

(5) Identification of Solvent Residue:

In order to determine a solvent residue of the film, 0.5 g of a sample was pre-treated at 200° C. for 30 minutes. The resultant volatile gas ingredient was analyzed through GC/MS to detect solvent residue ingredients. The detected solvent residue ingredients were classified into a low boiling point solvent as “low”, a moderate boiling point solvent as “middle”, and a high boiling point solvent as “high.” The determined results are shown in Table 2.

(6) Elongation:

In order to determine an elongation of an adhesive film, each film was prepared to have a size of 5 mm×20 mm, sufficient to be gripped using jigs at both sides. Elongation was determined using a UTM instrument equipped with a 100 N load cell. The results are shown in Table 1.

(7) Determination of Melt Viscosity:

In order to determine a viscosity of each film, the film was fabricated by laminating four adhesive layers together at 60° C., and then cut into a round piece having a diameter of 25 mm and a thickness of 400 to 440 μm. The film was subjected to melt viscosity determination while elevating the temperature from 30° C. to 130° C. at 5° C./min. Table 2 shows Eta values at different temperatures particularly including: at 25° C. before curing; at 100° C. as a die attach temperature at which fluidity is determined; and at 130° C. at which filling of uneven portions in a wire is determined.

(8) Determination of Elastic Modulus Before and After Curing:

In order to determine an elastic modulus of each film, the film was fabricated by laminating four adhesive layers together at 60° C., the film having a size of 25 mm and a thickness of 400 to 440 μm before curing, and 200 to 300 μm after curing. After the curing was completed, the cured film was subjected to elastic modulus determination while elevating the temperature from 30 to 260° C. at 4° C./min. The determination was performed using a DMA, TA Instruments model Q800.

(9) Determination of Adhesive Ability:

A wafer having a thickness of 725 μm and coated with a dioxide film was cut to a size of 5 mm×5 mm. The prepared wafer piece was laminated with an adhesive film at 60° C., followed by cutting the laminate to obtain an adhesive coated wafer piece. Another wafer having a thickness of 725 μm and a size of 10 mm×10 mm, and which was coated with a photosensitive polyimide, was placed on a hot plate at 100° C., followed by compressing the former wafer piece to the later wafer at 1.0 kgf for 1.0 second. Such compression was repeated at 125° C. for 1 hour then at 175° C. for 3 hours. The treated wafer piece was subjected to determination of fracture strength at 270° C. after moisture absorption for 48 hours at 85° C. and 85% RH.

(10) Determination of Storage Stability:

After storing each film at room temperature for 30 days, the film was subjected to determination of a melt viscosity at 100° C. and an adhesive ability thereof. The measurement results are shown in Table 2, in which each is a variation compared to an initially measured value.

As is apparent from Table 2, it was found that using the high boiling point solvent in Examples 1 and 2 generated foaming voids (caused by volatile materials) of less than 5%. Even after the foaming voids were subjected to a variation in processing temperatures from 125° C. to 175° C., no substantial volume expansion was observed. Using only the low boiling point solvent in Comparative Example 3 also generated foaming voids while little volume expansion was observed, which is similar to Examples 1 and 2. However, for the composition in Comparative Example 3 containing only the low boiling point solvent, a number of air bubbles on a surface of an adhesive film were observed, thereby causing problems such as surface unevenness. In Comparative Example 4, using the composition containing the moderate and low boiling point solvents without the high boiling point solvent, volatile foaming was observed at a processing temperature and a relatively large volume expansion of gaps or voids was identified. In Comparative Example 5, using the composition less than 10% of the high boiling point solvent, volatile foaming was observed at a processing temperature and a relatively large volume expansion of gaps or voids was identified. It is expected that these compositions of the Comparative Examples may cause problems with reliability of the film due to voids during EMC molding or under high temperature and high humidity conditions.

A requirement for an adhesive film may be that the film is an “attached void free type” film. The film must ensure excellent reliability in semiconductor assembly, especially, to fabricate a die-to-die laminate structure. The adhesive film prepared in Examples 1 and 2 resulted in a reduced generation of volatile voids and controlled volume expansion of voids and/or gaps. This reduced generation of volatile voids is clearly distinguished from the result observed in Comparative Example 3, in which 10 to 15% or more voids generated due to a hard surface of an adhesive film, and cannot be used for filling a wire in semiconductor assembly. Among adhesive films having the essential features in that the film is an “attached void free type” film and can completely fill a wire, the films in Comparative Examples 4 and 5 show that volume expansion of voids was increased 5 to 10% by a moderate boiling point solvent residue remaining after die attachment. This increase in volume expansion may induce laminate voids, accelerating the volume expansion at high temperatures and causing a failure in reliability of the film.

Comparative Example 2 shows volatile voids generated by a high boiling point solvent and volume expansion of voids which were similar to results in Examples 1 and 2. However, since an amount of a solvent residue in an adhesive film was more than about 2%, the film had an excessively high ductility to increase elongation of the film 2 or 3 times compared to Examples 1 and 2. In addition, increased surface tacking properties caused a problem in separation of the adhesive film and an alterative attachment film during die attachment.

Physical properties of films obtained from Examples 1 and 2, and

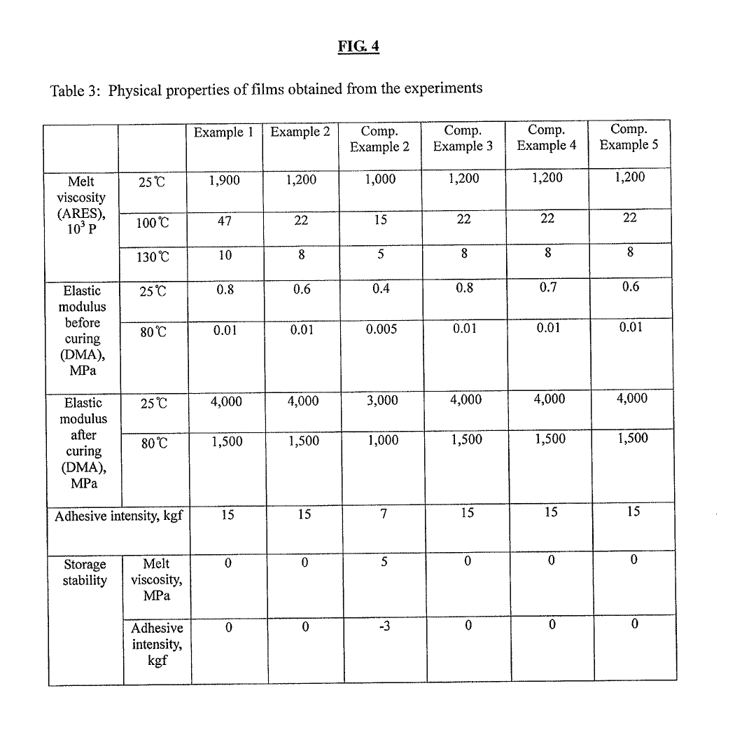

Comparative Examples 2 to 5 were compared as shown in Table 3 in FIG. 4. Each film in Examples 1 and 2 had an improved ductile structure so as to prevent the film from being cut and to exhibit a favorable elongation while improving hardness. These results can be identified from determined elongations shown in Table 2. The “attached void free type” film generally has an increased content of a curable portion and contains a relatively large amount of filler particles, thus causing high brittleness of the film. However, the adhesive films prepared in the Examples using the high boiling point solvent may eliminate such a problem.

As disclosed above, the composition according to preferred embodiments may be used to fabricate an adhesive film containing less than about 2% high boiling point solvent residue. The fabricated adhesive film may simultaneously satisfy a ductile structure and an improved tensile strength of the film even with an increased content of a curable resin, thereby exhibiting an improved hardness without being cut. Moreover, since volatile ingredients inducing voids have a high boiling point, voids generated by volatilization of a solvent in semiconductor assembly were considerably reduced. As a result, volume expansion of gaps or voids generated on a surface of the film was also decreased, thereby ensuring high reliability in semiconductor assembly.

Consequently, adhesive films prepared according to embodiments have high fluidity at high temperatures, may be an “attach void free type” film, and may completely fill a wire so as to decrease gaps or voids generated due to uneven portions of the wire, which may be caused in semiconductor assembly. Thus, adhesive films prepared according to embodiments may be used to fabricate a die-to-die laminate structure, thereby ensuring excellent reliability in semiconductor assembly.

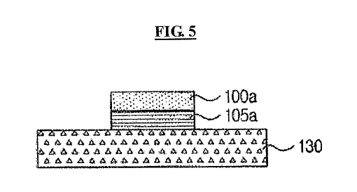

FIG. 5 illustrates a device package including a die, an attachment film layer, and a next-level substrate according to an embodiment. Referring to FIG. 5, an attachment film layer 105a including an adhesive film according to an embodiment may be disposed between a die 100a and a next level substrate 130. The die may be, e.g., a semiconductor die, an optical or electro-optical die, a microelectromechanical system (MEMS) die, etc. The next-level substrate may be, e.g., another die, a printed circuit board, an interposer, etc. The die 100a and the attachment film layer 105a may be encapsulated, e.g., with an epoxy molding compound, etc., on the next-level substrate 130.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

1.-12. (canceled)

13. An adhesive film for semiconductor assembly fabricated using a composition, the composition including:
a polymer binder;
a curable resin; and
solvent, wherein:
the solvent is a binary solvent consisting essentially of a first solvent with a boiling point of about 40° C. to about 100° C. and a second solvent with a boiling point of about 140° C. to about 200° C., and
the adhesive film contains less than about 2 wt. % of the solvent.

14. The adhesive film as claimed in claim 13, wherein the adhesive film has an elongation of about 150 to about 400%.

15. The adhesive film as claimed in claim 13, wherein the adhesive film has a storage elastic modulus of about 0.1 to about 10 MPa at 25° C. and another storage elastic modulus of about 0.01 to about 0.10 MPa at 80° C.

16. The adhesive film as claimed in claim 13, wherein the adhesive film has a melt viscosity at 25° C. of about 1,000,000 to about 5,000,000 P and a surface tacking value of less than about 0.1 gf.

17. The adhesive film as claimed in claim 13, wherein the adhesive film exhibits less than about 5% volatile voids.

18. The adhesive film as claimed in claim 13, wherein the adhesive film contains more than zero wt. % of the solvent.

19-23. (canceled)

24. An adhesive film for semiconductor assembly fabricated using a composition, the composition including:
a polymer binder;
a curable resin; and
solvent, wherein:
the adhesive film contains less than about 2 wt. % of the solvent and exhibits less than about 5% volatile voids.
